(19) United States
(12) Patent Application Publication
(10) Pub. No.: US 2020/0177476 A1
(43) Pub. Date: Jun. 4, 2020

(54) Database Platform Integration with Third-Party CRM Services

(71) Applicant: SAP SE, Walldorf (DE)

(72) Inventors: Mukesh Kumar AGARWAL, Rajasthan (IN); Nipun Dev, Bangalore (IN); Najam Ahmad, Gurgaon (IN)

(21) Appl. No.: 16/203,947

(22) Filed: Nov. 29, 2018

(51) Int. Cl. H04L 12/24; G06F 16/27; G06F 16/25; G06F 9/54

(52) U.S. Cl. CPC H04L 41/5064; G06F 9/547; G06F 16/252; G06F 16/27

(57) ABSTRACT

Disclosed herein are system, computer-implemented method, and computer program product (computer-readable storage medium) embodiments for implementing database cloud platform integration with third-party CRM services. An embodiment includes operating first and second computer systems and interfacing with first and second database components, respectively, that are differently formatted. An embodiment may further include replicating data from the second database component to the first database component via the integration artifact according to at least one state-management framework, transforming the data to include at least one metadata element not present in the second database component according to the different formats of the first database component and the second database component, storing the data transformed by the transforming, into the first database component, and accessing, from the first computing system, the data stored by the storing, in a same manner as directly accessing the data from the second database component.

### BACKGROUND

Customer relationship management (CRM) software and services span broad markets with numerous and diverse offerings of proprietary platforms each having unique features and interfaces. The same may be said of commercial database platforms, such as for electronic commerce (e-commerce or EC) and enterprise resource planning (ERP), to name a few examples. As such software and services have become increasingly distributed and cloud-based, expectations of business users have evolved to demand more cross-compatibility and interoperability of popular CRM and EC offerings.

Although such CRM, EC, and ERP platforms may provide application programming interfaces (APIs) for their business customers, differing feature sets from one platform to another have resulted in considerable difficulties impeding smooth integration of many CRM platforms with many EC platforms, as some EC platforms may not accommodate corresponding features of CRM platforms, and vice-versa, leading to sub-optimal functionality and performance of CRM-EC-ERP integration solutions.

One way in which e-commerce-oriented businesses have dealt with such integration problems has been to buy their software and services for CRM and EC both from the same platform vendor for each. However, this is not always an option for many business customers in the market for CRM and EC in the modern business space, for a variety of reasons. For example, a CRM customer's business may be entrenched in a model that depends on unique features from one CRM provider but cannot use or afford EC solutions from the same provider. In other cases, other business may be wary of vendor lock-in from the start, and may prefer to buy into a vendor's solutions for CRM, EC, or both, only on the condition that any solution includes a high degree of flexibility and cross-compatibility that would allow for easy transitions to other platforms in the future. Various ways of providing such integrations have been lacking and have required significant sacrifices in functionality and performance.

### BRIEF DESCRIPTION OF THE DRAWINGS

The accompanying drawings are incorporated herein and form a part of the specification.

FIG. 1 is a diagram of computer systems, including platforms and components, that may implement and benefit from the enhanced techniques described herein, according to some embodiments.

FIG. 2 is a diagram illustrating an example interaction among some system components corresponding to elements depicted in FIG. 1, according to some embodiments.

FIG. 3 is a diagram depicting a transparent interaction between an e-commerce platform and a CRM platform, according to some embodiments.

FIG. 4 is a flowchart illustrating a process implementing some of the enhanced techniques described herein, according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for implementing database platform integration with third-party customer relationship management (CRM) services. Example applications may include e-commerce platform integration with specific CRM platforms. In some embodiments, any of the database or e-commerce platforms may be cloud-based, along with any CRM platform.

Techniques described herein may enhance functionality and/or performance of platform integrations, thus improving compatibility, but may also thereby enhance individual platforms themselves. Benefits, advantages, and improvements of implementing these enhanced techniques are not limited to the specific examples mentioned here.

For some non-limiting examples referenced in this detailed description, e-commerce platforms may refer to database-driven systems that include functionality of facilitating business transactions electronically and/or tracking records thereof. The business transactions may involve businesses selling goods or services to consumers (B2C), or to other businesses (B2B). In some embodiments, e-commerce platforms may facilitate sales between private consumers without specific business entities being involved. E-commerce platforms, as described herein, may further include multichannel solutions for payment, inventory tracking, and/or fulfillment, in some embodiments.

For some non-limiting examples referenced in this detailed description, CRM platforms may refer to database-driven systems that include functionality for opportunity management, tracking origination and conversion on business or sales leads, for example. In an e-commerce context, visitors who access an e-commerce platform may be treated as sales leads or opportunities in CRM integrated with the e-commerce platform, in an embodiment. Additionally, or alternatively, for purposes of this disclosure, CRM may refer to various other aspects of enterprise resource planning (ERP), in some embodiments, including multichannel solutions for marketing, advertising, and/or consumer tracking, for example.

For any of the above database-driven systems or platforms, various functionalities may be available to customers (often in the form of businesses) who employ these platforms as solutions—in turn, some of these various functionalities may be available to end-users of the platforms, often consumers, other businesses, suppliers, or other parties to e-commerce transactions. Additionally, a database management system (DBMS) such as a non-relational or a relational database management system (RDBMS) may be separately implemented to drive one or more other platforms (e.g., e-commerce and/or CRM), and may implement its own unique functionalities that may (or may not) be supported in any of the platforms or may also be involved in any integrations across the database-driven systems or platforms.

Examples of such functionalities include data analytics, reporting, visualizations, bulk data exchange or ingestion, import or export of various processed or unprocessed data sets (e.g., contact lists, leads, etc.), which may benefit from having compatible formats and protocols in common with other systems. Each of these functionalities may involve unique data formats, query languages, interfaces (e.g., application programming interface (API) hooks, etc.), or other ways for users or different systems to interact with a given platform.

While certain open standards may facilitate some aspects of the above functionalities, additional compatibility measures may be useful when leveraging unique functionalities of a given platform, without sacrificing such functionalities for the sake of compatibility. To realize gains in this respect, enhanced techniques such as those further described herein may be used for efficiently integrating disparate platforms without overhead of using generic protocols, formats, APIs, etc., for a specific pair of systems. More efficient integration, e.g., of e-commerce platforms and CRM, may further facilitate omnichannel commerce leveraging integration of various business platforms, resulting in improved end-user experiences as well as more reliable and meaningful data for those who purchase or employ such integrated solutions for business.

Additional benefits of these enhanced techniques include being able to retain specific features of a given platform (e.g., an e-commerce platform) within another platform (e.g., a CRM platform) that does not specifically account (e.g., in an API) for the specific features of the given platform. Thus, where a target platform's API is insufficient for data needs of a source platform, separate compatibility layers may be configured in the source platform to effect integrations in the target platform, such as using the target platform's API in a manner not intended by the target platform, or by leveraging other techniques available for the given source and destination platforms.

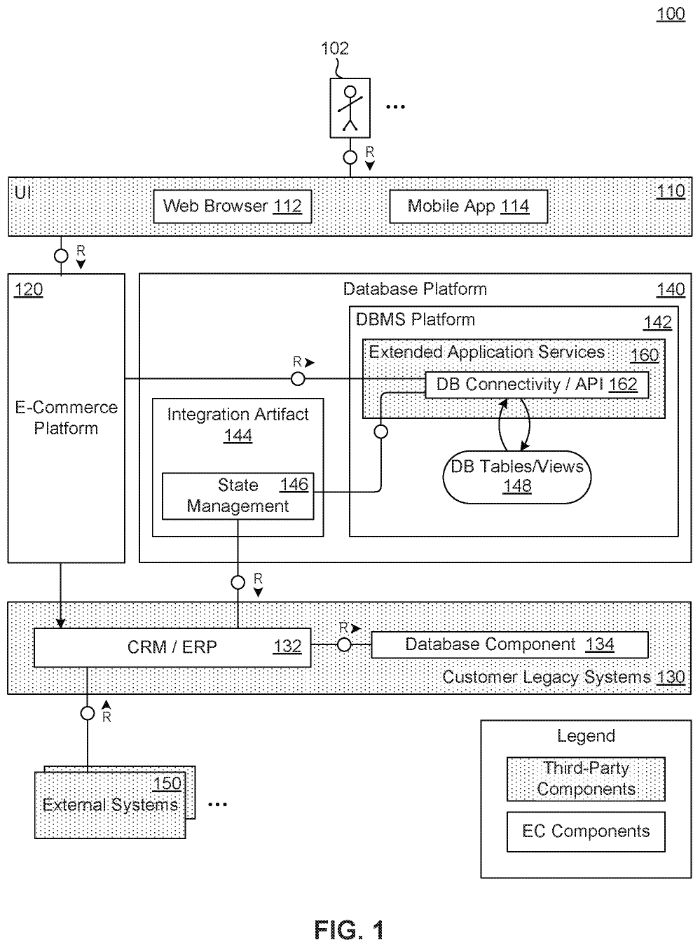

One non-limiting example of a set of computer systems 100, including platforms and components, that may benefit from the enhanced techniques described herein is depicted in the example of FIG. 1. An accompanying description of FIG. 1 follows in the paragraphs below.

A user 102 may access the systems and data therein via an end-user platform such as web browser 112 or mobile app 114. Any user interface (UI) 110 presented via such an end-user platform may be a same interface presented when accessing the first computing system or the second computing system, for example. The end-user platform(s) such as web browser 112 or mobile app 114 may, in some embodiments via UI 110, access an e-commerce platform 120 as part of a first computing system.

The e-commerce platform 120 may be communicatively coupled to a database platform 140 and any of various third-party systems, such as customer legacy systems 130 and/or other external systems 150, which may be coupled to e-commerce platform 120 directly (not shown) or indirectly via at least one customer legacy system 130. Customer legacy systems 130 may include, for example, at least one CRM solution (CRM platform or CRM system), which may be part of a broader ERP solution (CRM/ERP 132), in some embodiments.

Similar applications may be used additionally or alternatively to CRM/ERP 132, e.g., manufacturing resource planning and material requirements planning, supply chain management, product lifecycle management (PLM), and/or business intelligence (BI), to name a few non-limiting examples. Further system components, including any number of modules, applications, and/or external systems 150 may interact with CRM/ERP 132 as shown.

In some embodiments, at least one external system 150, or end-user platform or interface 110-114, may interact with e-commerce platform 120 and thereby with database platform 140 and included components, e.g., DBMS platform 142, constituting at least a first computing system or platform. However, any of 110-114 may additionally or alternatively be configured to interact with a second database component, such as database component 134, separate from 140, in a manner compatible with a second computing system or platform that includes customer legacy systems 130. Such interactions may instead be converted, translated, or otherwise transformed by processor 504 via the integration artifact 144, such as using state-management 146 framework, to be compatible with a database connectivity component or API 162 within extended application services 160 (e.g., micro-service(s), web server(s), or web application(s) running thereon) that may, in some embodiments, be part of DBMS platform 142.

Specifically, shown here is at least one CRM and/or ERP module (CRM/ERP 132). In some embodiments. CRM and ERP may be integrated as the same element (CRM/ERP 132), and may interact with any local, on-premises, and/or cloud-based computing resources or services, for example, which may include at least one database platform 140, via at least one integration artifact 144 including at least one state-management 146 framework, comprising any number of database tables and/or views (DB tables/views 148) further accessible at least by database connectivity component or API 162 as part of the extended application services 160. The elements shown in FIG. 1 depict an example embodiment for illustrative purposes and are not intended to represent specific requirements or limitations for other comparable systems.

Specific examples of CRM systems or platforms may include solutions available from salesforce.com (SFDC), Zoho CRM, Tryton, Nutshell CRM, Dynamics CRM, or any other comparable solution, to provide a few non-exhaustive and non-limiting examples. Specific examples of e-commerce systems or platforms may include Shopify, Episerver, Commerce Cloud, Business Catalyst, Magento, Volusion, Miva Merchant, BigCommerce, Weebly, Wix eCommerce, WooCommerce, Kentico, and other comparable solutions, to name a few examples that are neither exhaustive nor limiting. Specific examples of DBMS platforms include, but are not limited to, relational and/or non-relational database management solutions such as Apache Derby, InterSystems Cache, MySQL, MariaDB, Berkeley DB, IBM Informix, OrientDB, PostgreSQL, InterBase, FirebirdSQL, and others. Connectivity elements or APIs may include the Open Data Protocol (OData), Open Database Connectivity (ODBC), Java Database Connectivity (JDBC), Object Linking and Embedding, Database (OLE-DB) API, various RESTful API implementations, or other suitable means. Virtually any combination of such components or comparable alternatives may be used.

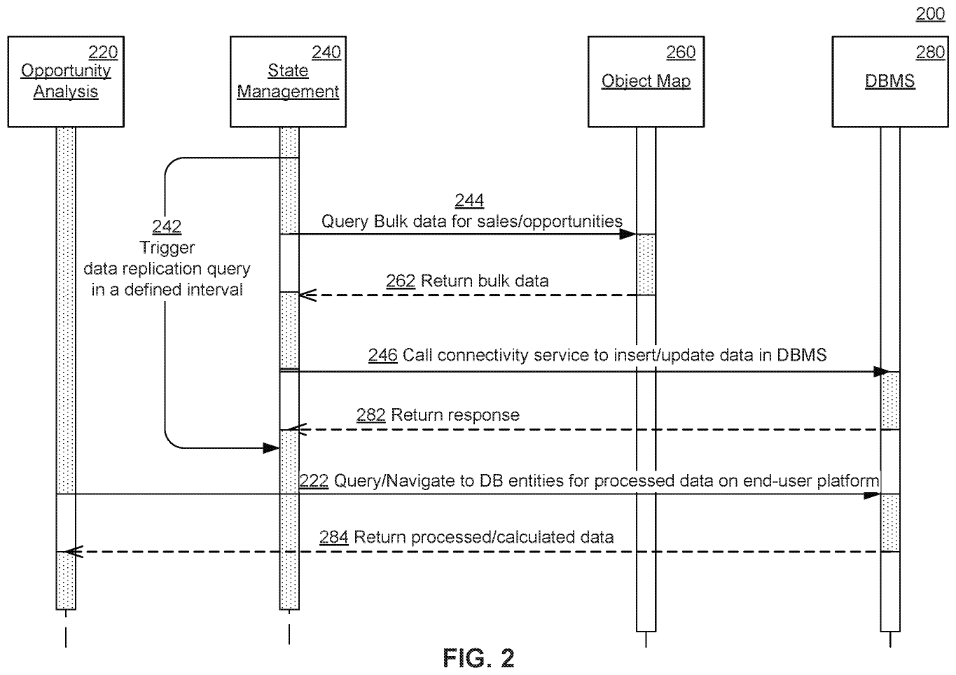

FIG. 2 shows an example interaction among some system components corresponding to elements depicted in FIG. 1, according to some embodiments. At a high level, this solution may provide a framework for standardizing interaction among disparate systems and/or components. As a practical implementation, the totality of steps (or any sub-combination thereof) shown in FIG. 2 may be treated as an example of a method 200 implementing enhanced techniques described herein for database platform integration with third-party services, according to some embodiments.

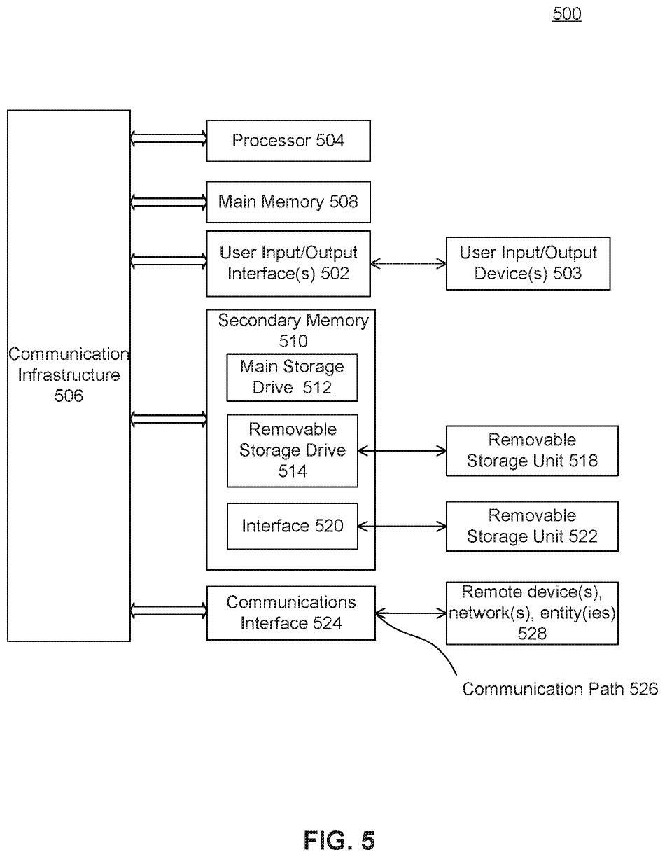

Method 200 shall be described with reference to FIGS. 1 and 5. However, method 200 is not limited only to those example embodiments. The steps of method 200 may be performed by at least one computer processor coupled to at least one memory device. An exemplary processor and memory device(s) are described below with respect to FIG. 5. In some embodiments, method 200 may be performed by system 100 of FIG. 1, which may further include at least one processor and memory such as those of FIG. 5.

Method 200 may be performed by processing logic that may comprise hardware (e.g., circuitry, dedicated logic, programmable logic, microcode, etc.), software (e.g., instructions executing on a processing device), or a combination thereof. Not all steps of method 200 may be needed in all cases to perform the enhanced techniques disclosed herein. Further, some steps of method 200 may be performed simultaneously, or in a different order from that shown in FIG. 2, as will be understood by a person of ordinary skill in the art.

A state of execution of at least one processor, such as processor 504 of FIG. 5, may be roughly categorized at a given time as being in a functional domain including one of opportunity analysis 220, state management 240, object map 260, and DBMS 280, although this list is non-exhaustive, and the functional domains are non-exclusive unless otherwise required.

In 242, from the functional domain of state management 240, processor 504 may trigger a data replication query in a defined interval. The data replication query may be directed to and/or compatible with a database component of a third-party platform, such as a database in a database-driven CRM or ERP solution provided by a third party, for example, referring to CRM/ERP 132 and the second database component (not shown), within customer legacy systems 130, in some embodiments. Within a full execution cycle of 242, any or all of 244, 246, 262, or 282 may occur, as described below.

In 244, processor 504 may query bulk data of sales and/or opportunities (sales leads) via object map 260 domain. This domain may correspond to an object map within the second database component (database component of a third-party platform), accessible by a predefined API, which may be public or private (keyed and/or metered, among other potential restrictions). The object map may provide a unique, abstracted interface and features to facilitate accessing data in ways that may be unique to the second database component, in some embodiments.

In 262, processor 504 may return bulk data, such as in response to the query of 244, from the object map 260 domain. In some embodiments, this action may be considered analogous to beginning a database replication operation, for example. Bulk data may be a dump of an entire database, table(s), dataset, or other denomination of data. Depending on the query, in some embodiments, the bulk data may refer to a relatively large selection of data matching part of a query, for example.

In 246, a database connectivity component or corresponding service or API may be called by processor 504, so as to insert or update data stored in a given database component, such as of a DBMS, via the DBMS 280 domain. In some embodiments, this action may be considered analogous to storing replicated data in a first database component, as part of a database platform coupled with an e-commerce platform or other related (non-third-party) system or platform.

In 282, responsive to the call of 246, processor 504 may return a response to the state management 240 domain, from the DBMS 280 domain. In so doing, a full execution cycle of 242 may be completed.

In 222, following an initial state or at least one completion of 242, processor 504 may, from an opportunity analysis 220 domain, query or navigate (e.g., by 110-114 of FIG. 1) to database entities (e.g., 140-148 and 160-162 of FIG. 1) to retrieve processed data, such as for an end-user. The processed data may be based on the replicated data from the object map of the second database component, but where the processing (selection, matching, analytics, etc.) may have been done in the first database component and accessed via an integration artifact from an end-user platform as if the first database component had been the second database component, in some embodiments, per further details described below.

In 284, responsive to the query or navigation of 222, processor 504 may return processed data to the opportunity analysis 220 domain, from the DBMS 280 domain. In so doing, a full execution cycle of method 200 may be completed. The processed data may include selected data, matched data, analyzed data, aggregated data, analytics, or some combination of these, to name a few non-limiting examples.

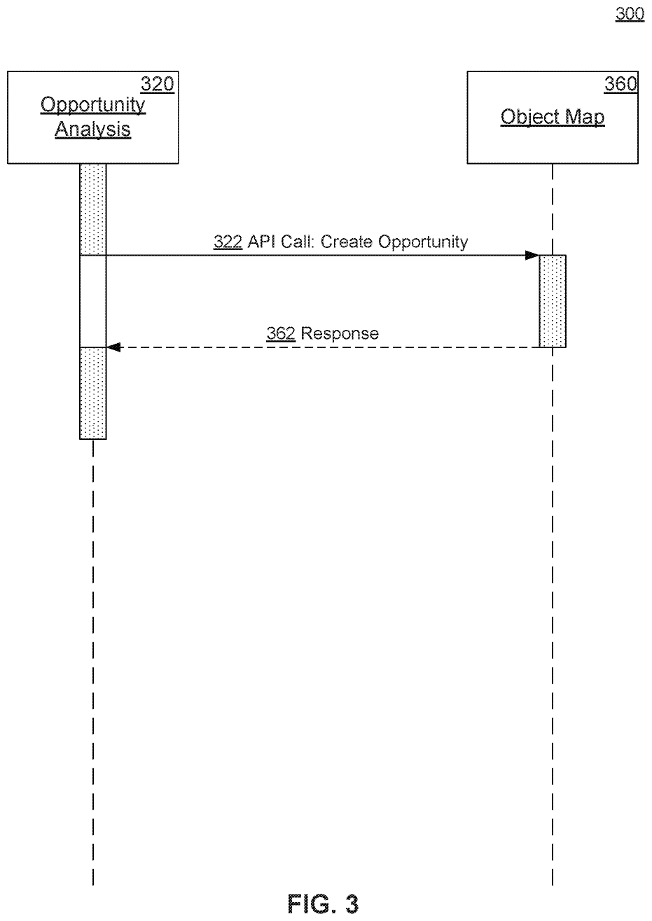

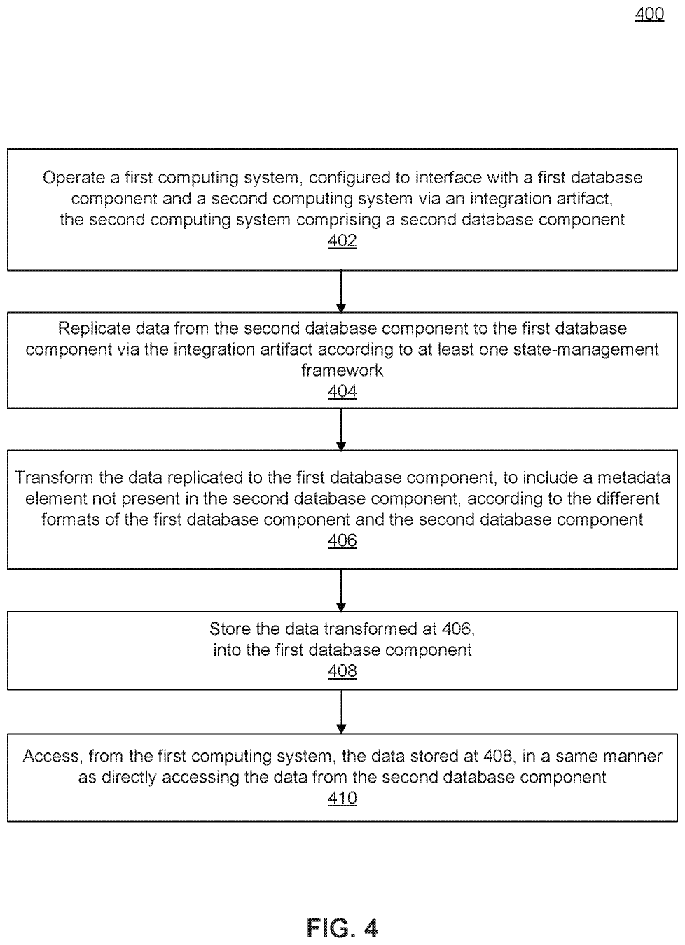

FIG. 3 shows a transparent interaction between an e-commerce platform and a CRM platform, corresponding to elements depicted in FIGS. 1 and 4, according to some embodiments. As a practical implementation, the totality of steps shown in FIG. 3 may be treated as an example of a method 300 implementing enhanced techniques described herein for database platform integration with third-party services, according to some embodiments.

For illustrative purposes, FIG. 3 shows only API call 322 and response 362 from object map 360 domain, but this example is not intended to be limiting. Rather, this example illustrates the transparency of the integration artifact and transformations taking place within the first database component(s) and corresponding database platform (e.g., 140 of FIG. 1), when viewed from a perspective of an end-user platform (e.g., 110-114 of FIG. 1). Any additional benefits of these techniques may also be apparent to persons having ordinary skill in the art.

Method 300 shall be described with reference to FIGS. 1 and 5. However, method 300 is not limited only to those example embodiments. The steps of method 300 may be performed by at least one computer processor coupled to at least one memory device. An exemplary processor and memory device(s) are described below with respect to FIG. 5. In some embodiments, method 300 may be performed by system 100 of FIG. 1, which may further include at least one processor and memory such as those of FIG. 5.

Method 300 may be performed by processing logic that may comprise hardware (e.g., circuitry, dedicated logic, programmable logic, microcode, etc.), software (e.g., instructions executing on a processing device), or a combination thereof. Not all steps of method 300 may be needed in all cases to perform the enhanced techniques disclosed herein. Further, some steps of method 300 may be performed simultaneously, or in a different order from that shown in FIG. 3, as will be understood by a person of ordinary skill in the art.

In 322, from the functional domain of opportunity analysis 320, processor 504 may generate or send an API call to the object map 360 domain. The API call may be configured to invoke a function, e.g., in an object map specific to a database component in a third-party platform, that would create a new opportunity (e.g., entering a new business lead). As a practical implementation, such an event may occur automatically, depending on a given CRM platform. For example, if a customer on a web browser 112 or mobile app 114 browses certain items in a certain way on a given e-commerce platform 120, meeting certain conditions either directly or based on more sophisticated calculations or analytics, processor 504 may automatically trigger such an API call to create a new sales lead in an opportunity database, in some embodiments.

In 362, responsive to the API call of 322 to create an opportunity, processor 504 may return a response to the opportunity analysis 320 domain, from the object map 360 domain. In so doing, a full execution cycle of method 300 may be completed, from the perspective of an end-user platform. The response may be an acknowledgment of the created opportunity, a pointer to a created database entry corresponding to the created opportunity, a copy of the database entry, or some combination of the above, among other possibilities.

From the perspective of an end-user platform (or software written therefor) to interface with the third-party database components (e.g., second database component, such as database component 134, of customer legacy systems 130), method 300 works the same as if it were accessing the second database component directly. However, in some embodiments, processor 504 may instead perform transformations on a back-end server to perform additional analytics, selections, and send/receive additional metadata, so as to enhance quality and performance of calculations and analytics performed by a different database component (e.g., first database component, such as DBMS platform 142, including 148 and 160). Reasons for such transformations are described throughout this Specification, and implementation details for such transformations are further described below, such as with respect to FIG. 4.

FIG. 4 is a flowchart illustrating a method 400 for operation of the enhanced database platform integration techniques described herein, according to some embodiments. Method 400 may be performed by processing logic that may comprise hardware (e.g., circuitry, dedicated logic, programmable logic, microcode, etc.), software (e.g., instructions executing on a processing device), or a combination thereof. Not all steps of method 400 may be needed in all cases to perform the enhanced techniques disclosed herein. Further, some steps of method 400 may be performed simultaneously, or in a different order from that shown in FIG. 4, as will be understood by a person of ordinary skill in the art.

Method 400 shall be described with reference to FIGS. 1-3 and 5. However, method 400 is not limited only to those example embodiments. The steps of method 400 may be performed by at least one computer processor coupled to at least one memory device. An exemplary processor and memory device(s) are described below with respect to FIG. 5. In some embodiments, method 400 may be performed by system 100 of FIG. 1, which may further include at least one processor and memory such as those of FIG. 5.

In 402, at least one processor 504 may be configured to operate at least a first computing system and a second computing system. The first computing system may be configured to interface with a first database component, for example. Additionally, the first computing system may be further configured to interface with the second computing system via an integration artifact, in some embodiments. Also, the second computing system may include a second database component. Directly or indirectly, via the second computing system, the first system may thus be configured to interface also with the second database component.

Further with respect to 402, the first database component may be formatted differently from the second database component. Different formatting may include, but is not limited to, different data structures, different interfaces, different metadata, different encodings, different organization, different orientation (e.g., row-oriented or column-oriented), different convertible values, etc. When the first database component is formatted differently from the second database component, additional system components using processor(s) 504 may be operable to perform transformations or additional operations as described below.

Additionally in 402, interfacing may be implemented via various types of interfaces, including but not limited to at least one API, application binary interface (ABI), command-line interface (CLI) or console equivalent that may be automated such as via a script, any exchange of a signal or token, virtually (such as via abstractions such as files, sockets, semaphores, etc.) or via electronic means (e.g., circuits, passive or active components thereof) or other physical means (e.g., mechanical, optical, audio, radio frequency (RF), etc.). As with an API, for example, interfacing by any other media also may involve standardization on specific protocols, formats, or data structures, for example. Interfacing may involve exchange of data across multiple computing systems or components thereof. Such data exchange may be unidirectional or multidirectional, from one computing system to another or vice-versa, as well as one to many, many to one, or many to many, according to some embodiments.

An integration artifact as described herein may be implemented in accordance with specific requirements of computing systems to be interfaced via the integration artifact. The integration artifact may be developed with capabilities of bulk data importation and exportation, ingestion, conversion, formatting, analytics, and/or other features that may facilitate access of at least one computing system by at least one other computing system, for example. The integration artifact may comprise at least one compatibility layer and/or translation layer between any two computing systems and may be configured to interface with various other computing systems in addition. The integration artifact may thus be used to render an object query for one computing system into a different type of query or command intended for or compatible with another different computing system, and/or relay output (such as of a result of the query or command) to another entity (e.g., requester) based at least in part on the output, the requesting entity, and/or a target entity (e.g., object of a request), in some embodiments.

The integration artifact may be used, for example, between a first computing system or platform and a second computing system or platform when replicating data from one such system or platform to the other. Specifically with regard to any compatibility layer or translation layer that may be utilized in implementing the integration artifact, such layer(s) may perform operations to transform data for replication, or accompanying metadata. These operations may include, in some embodiments, converting or transforming function calls or API calls of one platform to corresponding functions or API calls of another platform, even if those functions have disparate parameters or arguments, for example, by transforming arguments according to predetermined patterns. Additional examples of such conversions or transformations are described with respect to 406 below.

In 404, processor 504 may be configured to replicate data from the second database component to the first database component (or vice-versa) via the integration artifact according to at least one state-management framework or state-management architecture. A state-management framework may include any number or combination of data bindings, messaging protocols, remote procedure call (RPC) protocols, serialization standards, or other means of data exchange. A few examples of these means include SOAP, XML, JSON, and any other RPC protocols or similar standards that may build on any of these. The state-management framework(s) may be used not only to manage exchange of data per se, but also specific selection of data or actions pertaining to replication, as well as retrieval, analytics, or other effects that may be performed with respect to the data to be replicated.

State-management framework functionality is not limited to these examples, or any particular manner of managing an application state. Some non-limiting examples of state-management frameworks include Redux, iFlow, NgRx, NGXS, Flux, Akita, Vuex, and other comparable libraries, components, architectures, or other frameworks, in some embodiments. By performing data replication via this state management, data replicated may be preserved in a separate location from its source, and may thereby also serve as a cache to decrease latency and increase speed of access and retrieval of the replicated data while it is at the first computing system as opposed to the second computing system, and may also improve uptime of the data in case the second computing system were to go offline unexpectedly, for example.

In 406, processor 504 may be configured to transform the data replicated to the first database component, to include at least one metadata element not present in the second database component, according to the different formats of the first database component and the second database component. Continuing with the description of the integration artifact and compatibility layers or translation layer as set forth above, in some cases, a compatibility layer or translation layer may not always transform arguments or parameters—in this case, processor 504 may pass arguments or parameters of a first function (having a first name) on the first platform to a second function (having a second name) on the second platform, without needing to change any arguments or parameters. In some cases, non-substantive formatting of arguments or parameters may be applied, such as sanitizing, reformatting, or re-encoding, but otherwise retaining the substance of the original arguments or parameters.

In other cases, such as where the first function has fewer parameters than the second function, a translation layer or compatibility layer (or other part of an integration artifact) may pad the additional parameters of the second function, using a predetermined padding pattern, for example. Such padding may serve no specific purpose other than avoiding warnings or errors from the second platform, in some embodiments, whereas other embodiments may use the padding in cases where it may be later retrieved, such as with data or metadata to be reassembled for use with the first platform, in other embodiments. Similarly, in cases where the first function has more parameters than the second function, parameters of the second function may be overloaded so as to reflect the additional parameters of the first function, and to preserve the additional parameters as needed for the first platform, to the extent possible in or allowed by the second platform.

Some elements of data or metadata to be preserved across calls from one system or platform to another system or platform may need to be preserved even when a given system or platform does not expressly support such data or metadata in the specific specifications (data structures, databases, data stores, headers, etc.) of the given system or platform. Thus, in some embodiments, using parts of an integration artifact, such as a translation layer or a compatibility layer, according to at least the examples above, at least one processor 504 may transform replicated data to include, from the first system or platform, a metadata element that is not present or supported in the second system or platform, for example.

In 408, processor 504 may be configured to store the data, transformed by the transforming of 406 above, into the first database component, in some embodiments. By storing the data in this manner, as transformed appropriately for storage in the first database component, the above-mentioned transformation and storage may further facilitate use of unique functionality provided by the first database component and/or the first computing system or platform on which the first database component may reside, including access to additional computing resources, larger data sets or data stores, more advanced analytics, more cost-efficient processing, economizing volume or call quantity on cost-metered APIs, higher degrees of privacy, and other benefits that the first computing system or platform may be able to provide that the second computing system or platform otherwise cannot readily achieve. Any unique features of the second database component may also be preserved in the first database component, for example.

In 410, processor 504 may be configured to access the data, stored by the storing of 408 above, in a same manner as directly accessing the data from the second database component. In other words, access to the data originally stored in the second database component and now correspondingly replicated in the first database component may proceed via the first database component or first computing system including the first database component, and the data or access thereto may be accordingly enhanced by the first database component or first computing system, but this accessing operation may be performed transparently, as if accessing the second database component or second computing platform.

Likewise, in other embodiments, the accessing of the data stored in the first database component may be performed as normally accessing the first database component, but also transparently leveraging benefits of the second database component or second computing platform. Accessing, in any direction, from or via any computing platform, may be enhanced to the extent that any interfacing and accessing may be performed via the integration artifact or the state-management framework of the integration artifact. An example of this transparency may be understood from FIG. 3 as described above, for example.

In further embodiments, for the data replicated and stored in the first database component, with respect to accessing this data in the same manner as accessing corresponding original data in the second database component as described above, this “same manner” may further include accessing the data via an end-user platform such as web browser 112 or mobile app 114. Any user interface 110 presented via such an end-user platform may be a same interface presented when accessing the first computing system or the second computing system, for example, in a way that would be transparent to an end-user depending on which interface, system, or platform the end-user had previously been using.

In further embodiments, for the data replicated and stored in the first database component, with respect to accessing this data in the same manner as accessing corresponding original data in the second database component as described above, this “same manner” may include an object query specific to the second database component, and wherein the data accessed may include the at least one metadata element specific to the first database component or a result of analytics specific to the first database component.

For example, where an external system 150 or end-user platform or interface 110-114 may be configured to send an object query specific to the second database component or second computing platform. However, instead of this object query going to the second database component or second computing platform, the object query may instead be converted, translated, or otherwise transformed by processor 504 via the database platform integration artifact 144, such as using state-management 146 framework, to be compatible with a database connectivity component or API 162 within extended application services 160 (e.g., micro-service(s), web server(s), or web application(s) running thereon) that may be part of DBMS platform 142. Thus, instead of going to the second database component, the object query may go to the first database component, which may then not only access the data requested with the object query, but also may retrieve any enhanced analytics results or additional metadata specific to the first database component (i.e., element(s) that the first database component may provide and that the second database component may not provide).

Further examples of such specific metadata elements may be included in specific data bindings, such as XML, JSON, or other suitable data binding or serialization formats. Another example of metadata that may be specific to the first database component or first computing platform may include user data or business data, such as specific roles and/or authorizations. Authorizations may be independent of roles, in some embodiments, or may be linked to specific roles. A given user may belong to at least one organizational hierarchy, and that user or hierarchy may include specific roles and/or authorizations, which may govern which data and analytics the given user may be allowed to access, for example. In some embodiments, multiple hierarchies may exist and may be interconnected.

Users may inherit roles or authorizations from certain hierarchical levels or organizations, to which the users may belong. Roles and authorizations may be implemented, in some embodiments, in data structures that map specific role(s) and/or authorization(s) to a given user or organization, for example. In business contexts, examples of roles may include partners, suppliers, purchasers, special customers, ordinary customers, potential customers, etc. Where there are multiple hierarchies that may be interconnected, it may be that the same entity who is a customer of a first business may also be an owner of a second business, having its own customers, for example. In the case of this same entity, it would not be appropriate to allow the same entity the same authorizations for the first business's customer(s) as would be allowed for the second business's customers.

Authorizations include but are not limited to absolute permissions to read, write, modify, or perform other actions on specific elements of data, queries, analytics, or other aspects of a given database or platform. Authorizations may additionally or alternatively be conditional, and may be activated depending on other parameters or arguments accompanying a query (e.g., transaction type, amount, etc.). Specific implementations of roles and/or authorizations may be validated against a given set of corresponding business rules for a particular test case, for example

Without the enhanced techniques described herein, helpful functionality of the first computing system may be unavailable if only accessing the second computing system directly—e.g., if all opportunities (sales leads) are given equal access permissions for a same class of user in the second computing system, for example, then the second computing system or second database component may treat all of these entries essentially equal, irrespective of actual roles, authorizations, or any combination of the above (e.g., role-based authorizations). It still may be inappropriate for certain users within a class of users to have access to all of these leads.

By contrast, the enhanced techniques shown herein allow for roles and authorizations, as stored in the first computing system with the first database component, to be preserved and observed when accessing the second computing system's data as replicated in the first computing system or when otherwise accessed from the second computing system via the first computing system. Such compatibility may facilitate presenting users with the information they need, separated from information they cannot or should not use, e.g., a business owner accessing an unrelated business owner's client sales leads. Without using something akin to the integration artifact in ways described herein, metadata and other data may otherwise entail managing system-specific attributes or metadata across multiple disparate third-party systems (e.g., CRM, ERP, DBMS, UI platforms, etc.) that may be unsuitable for storing and properly handling such information.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a bus or communication infrastructure 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, vector processing, array processing, etc., as well as cryptography (including brute-force cracking), generating cryptographic hashes or hash sequences, solving partial hash-inversion problems, and/or producing results of other proof-of-work computations for some blockchain-based applications, for example.

Additionally, one or more of processors 504 may include a coprocessor or other implementation of logic for accelerating cryptographic calculations or other specialized mathematical functions, including hardware-accelerated cryptographic coprocessors. Such accelerated processors may further include instruction set(s) for acceleration using coprocessors and/or other logic to facilitate such acceleration.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or secondary memory 510. Secondary memory 510 may include, for example, a main storage drive 512 and/or a removable storage device or drive 514. Main storage drive 512 may be a hard disk drive or solid-state drive, for example. Removable storage drive 514 may be a floppy disk drive, a magnetic tape drive, a compact disk drive, an optical storage device, tape backup device, and/or any other storage device/drive.

Removable storage drive 514 may interact with a removable storage unit 518.

Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communication path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet of Things (IoT), and/or embedded system, to name a few non-limiting examples, or any combination thereof.

Computer system 500 may be a client or server, accessing or hosting any applications and/or data through any delivery paradigm, including but not limited to remote or distributed cloud computing solutions, local or on-premises software (e.g., “on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), database as a service (DBaaS), etc.); and/or a hybrid model including any combination of the foregoing examples or other services or delivery paradigms.

Any applicable data structures, file formats, and schemas may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

Any pertinent data, files, and/or databases may be stored, retrieved, accessed, and/or transmitted in human-readable formats such as numeric, textual, graphic, or multimedia formats, further including various types of markup language, among other possible formats. Alternatively or in combination with the above formats, the data, files, and/or databases may be stored, retrieved, accessed, and/or transmitted in binary, encoded, compressed, and/or encrypted formats, or any other machine-readable formats.

Interfacing or interconnection among various systems and layers may employ any number of mechanisms, such as any number of protocols, programmatic frameworks, floorplans, or application programming interfaces (API), including but not limited to Document Object Model (DOM), Discovery Service (DS), NSUserDefaults, Web Services Description Language (WSDL), Message Exchange Pattern (MEP), Web Distributed Data Exchange (WDDX), Web Hypertext Application Technology Working Group (WHATWG) HTML5 Web Messaging, Representational State Transfer (REST or RESTful web services), Extensible User Interface Protocol (XUP), Simple Object Access Protocol (SOAP), XML Schema Definition (XSD), XML Remote Procedure Call (XML-RPC), or any other mechanisms, open or proprietary, that may achieve similar functionality and results.

Such interfacing or interconnection may also make use of uniform resource identifiers (URI), which may further include uniform resource locators (URL) or uniform resource names (URN). Other forms of uniform and/or unique identifiers, locators, or names may be used, either exclusively or in combination with forms such as those set forth above.

Any of the above protocols or APIs may interface with or be implemented in any programming language, procedural, functional, or object-oriented, and may be compiled or interpreted. Non-limiting examples include C, C++, C#, Objective-C, Java, Swift, Go, Ruby, Perl, Python, JavaScript, WebAssembly, or virtually any other language, with any other libraries or schemas, in any kind of framework, runtime environment, virtual machine, interpreter, stack, engine, or similar mechanism, including but not limited to Node.js, VS, Knockout, jQuery, Dojo, Dijit, OpenUI5, AngularJS, Express.js, Backbone.js, Ember.js, DHTMLX, Vue, React, Electron, and so on, among many other non-limiting examples.

Chaincode or smart contract terms may be encoded or programmed using at least some of the above programming languages and/or frameworks, e.g., Node.js with JavaScript, other general-purpose programming languages such as Go, and/or domain-specific languages such as Solidity, to name a few non-limiting examples. Any additional libraries, shim code, middleware, APIs, or other logic may be introduced to make smart instruments reliably executable (or self-executable) on any given target platform(s) for development, testing, staging, and/or deployment to production, according to some embodiments.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments may operate with software, hardware, and/or operating system implementations other than those described herein.

It is to be appreciated that the Detailed Description section, and not any other section, is intended to be used to interpret the claims. Other sections may set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different from those described herein.

References herein to “one embodiment,” “an embodiment,” “an example embodiment,” “some embodiments,” or similar phrases, indicate that the embodiment described may include a particular feature, structure, or characteristic, but every embodiment may not necessarily include the particular feature, structure, or characteristic. Moreover, such phrases are not necessarily referring to the same embodiment.

Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

We claim:

1. A computer-implemented method, comprising:
operating, by at least one processor, a first computing system, configured to interface with a first database component and with a second computing system comprising a second database component via an integration artifact, wherein the first database component is formatted differently from the second database component;
replicating, by the at least one processor, data from the second database component to the first database component via the integration artifact according to at least one state-management framework;
transforming, by the at least one processor, the data replicated to the first database component, to include at least one metadata element not present in the second database component, according to the different formats of the first database component and the second database component;
storing, by the at least one processor, the data transformed by the transforming, into the first database component; and
accessing, by the at least one processor, from the first computing system, the data stored by the storing, in a same manner as directly accessing the data from the second database component.

2. The computer-implemented method of claim 1, wherein the at least one state-management framework comprises at least one of a messaging protocol or remote procedure call (RPC) protocol.

3. The computer-implemented method of claim 1, wherein the same manner comprises at least one end-user platform, comprising at least one of a web browser or a mobile application, and wherein the first database component is part of a database platform comprising a database management system (DBMS) configured to interface with the at least one state-management framework.

4. The computer-implemented method of claim 1, wherein the same manner comprises at least one application programming interface (API) call specific to the second database component, and wherein the data accessed comprises the at least one metadata element or a result of analytics specific to the first database component.

5. The computer-implemented method of claim 1, wherein the same manner comprises at least one object query specific to the second database component, and wherein the data accessed comprises the at least one metadata element specific to the first database component or a result of analytics specific to the first database component.

6. The computer-implemented method of claim 5, wherein the at least one state-management framework comprises a data binding for the at least one object query, and wherein the data binding comprises the at least one metadata element.

7. The computer-implemented method of claim 1, wherein the first computing system is configured to be operated as an electronic commerce platform or component thereof, and wherein the second computing system is configured to be operated as a customer relationship management (CRM) platform or component thereof.

8. A system, comprising:
a memory; and
at least one processor, coupled to the memory, and configured to:
operate a first computing system, configured to interface with a first database component and a second computing system via an integration artifact, the second computing system comprising a second database component, wherein the first database component is formatted differently from the second database component;
replicate data from the second database component to the first database component via the integration artifact according to at least one state-management framework;
transform the data replicated to the first database component, to include at least one metadata element not present in the second database component, according to the different formats of the first database component and the second database component;
store the data transformed by the transforming, into the first database component; and
access, from the first computing system, the data stored by the storing, in a same manner as directly accessing the data from the second database component.

9. The system of claim 8, wherein the at least one state-management framework comprises at least one of a messaging protocol or remote procedure call (RPC) protocol.

10. The system of claim 8, wherein the same manner comprises at least one end-user platform, comprising at least one of a web browser or a mobile application, and wherein the first database component is part of a database platform comprising a database management system (DBMS) configured to interface with the at least one state-management framework.

11. The system of claim 8, wherein the same manner comprises at least one application programming interface (API) call specific to the second database component, and wherein the data accessed comprises the at least one metadata element specific to the first database component or a result of analytics specific to the first database component.

12. The system of claim 8, wherein the same manner comprises at least one object query specific to the second database component, and wherein the data accessed comprises the at least one metadata element or a result of analytics specific to the first database component.

13. The system of claim 12, wherein the at least one state-management framework comprises a data binding for the at least one object query, and wherein the data binding comprises the at least one metadata element.

14. The system of claim 8, wherein the first computing system is configured to be operated as an electronic commerce platform or component thereof, and wherein the second computing system is configured to be operated as a customer relationship management (CRM) platform or component thereof.

15. A non-transitory computer-readable storage medium having instructions stored thereon that, when executed by at least one computing device, cause the at least one computing device to perform operations comprising:
operating a first computing system, configured to interface with a first database component and a second computing system via an integration artifact, the second computing system comprising a second database component, wherein the first database component is formatted differently from the second database component;
replicating data from the second database component to the first database component via the integration artifact according to at least one state-management framework;
transforming the data replicated to the first database component, to include at least one metadata element not present in the second database component, according to the different formats of the first database component and the second database component;
storing the data transformed by the transforming, into the first database component; and
accessing, from the first computing system, the data stored by the storing, in a same manner as directly accessing the data from the second database component.

16. The non-transitory computer-readable storage medium of claim 15, wherein the at least one state-management framework comprises at least one of a messaging protocol or remote procedure call (RPC) protocol.

17. The non-transitory computer-readable storage medium of claim 15, wherein the same manner comprises at least one end-user platform, comprising at least one of a web browser or a mobile application, and wherein the first database component is part of a database platform comprising a database management system (DBMS) configured to interface with the at least one state-management framework.

18. The non-transitory computer-readable storage medium of claim 15, wherein the same manner comprises at least one application programming interface (API) call specific to the second database component, and wherein the data accessed comprises the at least one metadata element or a result of analytics specific to the first database component.

19. The non-transitory computer-readable storage medium of claim 15, wherein the same manner comprises at least one object query specific to the second database component, and wherein the data accessed comprises the at least one metadata element specific to the first database component or a result of analytics specific to the first database component.

20. The non-transitory computer-readable storage medium of claim 19, wherein the at least one state-management framework comprises a data binding for the at least one object query, and wherein the data binding comprises the at least one metadata element.
